(19) United States
(12) Patent Application Publication
(10) Pub. No.: US 2025/0167280 A1
(43) Pub. Date: May 22, 2025

(54) METHODS AND SYSTEMS FOR LAMINATING LAYERS OF SOLID-STATE BATTERIES CONTINUOUSLY OR SEMI-CONTINUOUSLY

(71) Applicant: CORNING INCORPORATED, CORNING, NY (US)

(72) Inventor: Eric Lee Thompson, Livonia, NY (US)

(21) Appl. No.: 18/946,023

(22) Filed: Nov. 13, 2024

Related U.S. Application Data
(60) Provisional application No. 63/600,844, filed on Nov. 20, 2023.

(51) Int. Cl. H01M 10/04

(52) U.S. Cl. CPC H01M 10/0468; H01M 10/0404; H01M 10/049

(57) ABSTRACT

Disclosed herein are embodiments of a method of laminating component layers of a solid-state battery. In the method, two or more component layers of a solid-state battery are advanced in a first direction. The two or more component layers include at least one of a continuous ribbon substrate or a carrier film. The two or more component layers are pressed between a first pressing chamber and a second pressing chamber to laminate the two or more component layers of the solid-state battery. The first pressing chamber is configured to apply a first pressure uniformly over a first surface area, and the second pressing chamber is configured to apply a second pressure uniformly over a second surface area. The first pressure is substantially equal to the second pressure, and the first surface area is substantially equal to the second surface area.

### CROSS-REFERENCE TO RELATED APPLICATIONS

This application claims the benefit of priority under 35 U.S.C. § 119 of U.S. Provisional Application No. 63/600,844 filed Nov. 20, 2023, the content of which is incorporated herein by reference in its entirety.

### BACKGROUND

The disclosure relates to solid state batteries and, in particular, to methods and systems for laminating layers of solid-state batteries.

Lithium-ion battery cells typically include a cathode, an anode, and a permeable separation membrane disposed therebetween. A liquid electrolyte fills the volume in the cell, soaking the electrodes and separation membrane. Lithium ions, which are intercalated in the electrodes, move between the electrodes through the electrolyte during charging and discharging. Such lithium-ion battery cells may experience short circuits because of lithium dendrite formation through the permeable separation membrane, and the liquid electrolyte is generally volatile, which can lead to flammability issues. In contrast to such lithium-ion battery cells, solid-state batteries are considered more reliable and safer. In addition, solid-state batteries have higher energy density because of their stability to lithium metal as an anode, and thus smaller volumetric construction. However, assembly of solid-state batteries is more labor and time intensive that for lithium-ion batteries with a liquid electrolyte.

### SUMMARY

According to a first aspect, embodiments of the present disclosure relate to a method of laminating component layers of a solid-state battery. In the method, two or more component layers of a solid-state battery are advanced in a first direction. The two or more component layers include at least one of a continuous ribbon substrate or a carrier film. The two or more component layers are pressed between a first pressing chamber and a second pressing chamber to laminate the two or more component layers of the solid-state battery. The first pressing chamber is configured to apply a first pressure uniformly over a first surface area, and the second pressing chamber is configured to apply a second pressure uniformly over a second surface area. The first pressure is substantially equal to the second pressure, and the first surface area is substantially equal to the second surface area.

According to a second aspect, embodiments of the present disclosure relate to a system. The system includes a plurality of spools configured to pay off two or more component layers of a solid-state battery. At least one component layer of the two or more component layers is a continuous ribbon substrate. The system further includes a set of rollers downstream of the plurality of spools. The set of rollers is configured to converge the two or more component layers in a stacked arrangement. A press is disposed downstream of the set of rollers, and the press comprises a first pressing chamber and a second pressing chamber configured to apply pressure to a section of the two or more component layers to laminate the two or more component layers in the section. The first pressing chamber is configured to apply a first pressure uniformly over a first surface area, and the second pressing chamber is configured to apply a second pressure uniformly over a second surface area. The first surface area is substantially equal to the second surface area, and the section corresponds to the first surface area and the second surface area over which the pressure is uniformly applied. The first pressure is substantially equal to the second pressure.

According to a third aspect, embodiments of the present disclosure relate to a laminate structure. The laminate structure includes two or more component layers of a solid-state battery. At least one component layer of the two or more component layers is a continuous ribbon substrate. Along a length of the laminate structure, the at least two component layers of the solid-state battery are laminated to each other.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. In the drawings:

FIG. 1 is a schematic representation of a solid-state battery cell including two or more component layers pressed together in a continuous or semicontinuous process, according to one or more exemplary embodiments;

FIG. 2 is a schematic representation of a continuous or semi-continuous process line for pressing ribbon component layers of a solid-state battery together, according to one or more exemplary embodiments;

FIG. 3 is a schematic representation of a continuous or semi-continuous process line for pressing ribbon component layers of a solid-state battery, including discrete components, together, according to one or more exemplary embodiments;

FIG. 4 is a schematic representation of a press having pressing chambers connected to a common fluid manifold, according to one or more exemplary embodiments;

FIG. 5 is a schematic representation of embossing rollers for forming alignment features in a sealing substrate, according to one or more exemplary embodiments; and

FIG. 6 is a schematic representation of a press including flexible, sealed fluid bladders, or soft rubber pads for applying pressure to the component layers, according to one or more exemplary embodiments.

### DETAILED DESCRIPTION

Reference will now be made in detail to various embodiments of methods and systems for continuously or semi-continuously pressing component layers of a solid-state battery together, examples of which are illustrated in the accompanying drawings. As will be discussed more fully below, the component layers are pressed together using substantially equal pressure applied to opposite sides of the component layers by a press in a continuous or semi-continuous process line. That is, at least one of the component layers is provided as a continuous ribbon substrate or on a continuous ribbon substrate that is continuously or semi-continuously advanced through a press for lamination of the component layers. For example, the process may be conducted in a roll-to-roll fashion in which component layers are paid off from spools and pressed while moving or while briefly stopped before being taken up on another downstream spool. Advantageously, the continuous or semi-continuous pressing of the component layers is less labor and time intensive than existing batch or piece-by-piece processing techniques. These and other aspects and advantages of the disclosed methods and systems will be described more fully below. The embodiments discussed herein are presented by way of illustration and not limitation.

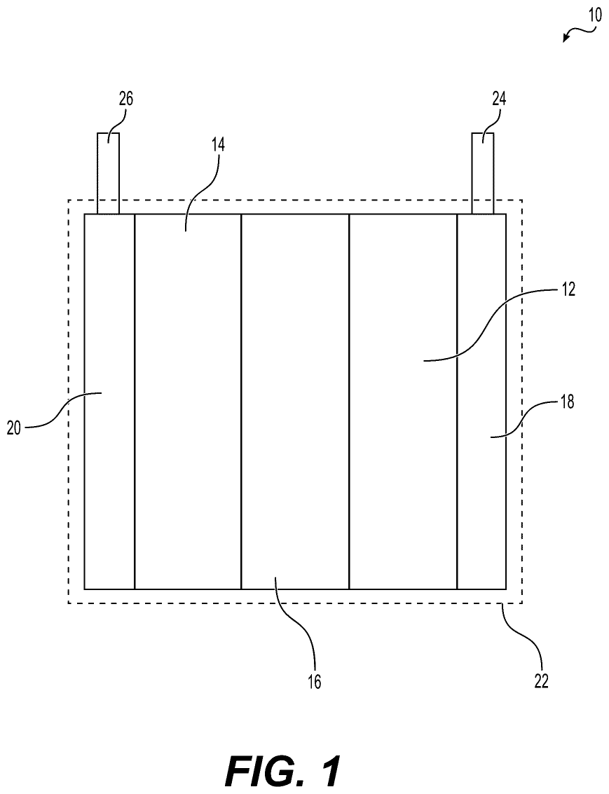

Solid state batteries are considered a promising technology for secondary batteries with high capacity and high energy density for such applications as electric vehicles, consumer electronics, and energy storage, amongst other possibilities. Solid state batteries are expected to provide higher performance and higher safety at lower cost compared to conventional wet electrolyte lithium-ion batteries. FIG. 1 schematically depicts a solid-state battery (SSB) cell 10 according to one or more exemplary embodiments. The SSB cell 10 includes a cathode 12, an anode 14, and a solid electrolyte 16. The solid electrolyte 16 is disposed between the cathode 12 and the anode 14. In one or more embodiments, the cathode 12 is comprised of a lithium- based oxide (such as lithium nickel cobalt aluminum oxide or lithium cobalt oxide), lithium- based phosphates (such as lithium iron phosphate), or vanadium oxide, for example. In one or more embodiments, the anode 14 is comprised of carbon, a titanate, a lithium alloy, or lithium metal. In one or more embodiments, the solid electrolyte 16 is comprised of a lithium garnet, such as lithium lanthanum zirconium oxide (LLZO) garnet having the formula of, e.g., Li₇La₃Zr₂O₁₂. LLZO garnet is considered a promising electrolyte for solid-state batteries because it has a high Li-ion conductivity (10⁻⁴ to 10⁻⁵ Scm⁻¹), a high Young's modulus (150 GPa), and a wide electrochemical window (>5 V vs. Li+/Li), and compatibility with lithium metal.

In one or more embodiments, the SSB cell 10 also includes a cathode current collector 18 and an anode current collector 20. In one or more embodiments, the current collectors 18, 20 are comprised of aluminum, copper, nickel, titanium, or stainless steel, among other possibilities. In one or more embodiments, the current collectors 18, 20 are foil, meshed foils, foams, or carbon coated foils, amongst other possibilities.

The cathode 12, anode 14, solid electrolyte 16, and current collectors 18, 20 of the SSB cell 10 may be contained in a housing 22 (such as a pouch) having a positive lead 24 and a negative lead 26 in electrical communication with the cathode 12 and anode 14, respectively. In the embodiment shown in FIG. 1, the SSB cell 10 includes a single cathode 12, a single anode 14, and a single solid electrolyte 16, but in one or more other embodiments, the SSB cell 10 includes a single or a plurality of cathodes 16, a single or a plurality of anodes 14, and a single or a plurality of solid electrolytes 16, in particular in a stacked arrangement with alternating electrode (cathode 12 or anode 14) and solid electrolyte 16. A plurality of SSB cells 10 may be connected to form a battery, and multiple batteries may be connected to form a module, which can, in turn, be assembled into a battery pack. The battery pack can then be used as a power source for, e.g., an electric vehicle.

Because the SSB cell 10 utilizes solid layers, maintaining contact between the layers is important for reducing interfacial impedance. In particular, unlike liquid lithium-ion batteries, the solid layers do not wet the adjacent surfaces. Therefore, certain layers of the SSB cell 10 may be pressed together to promote contact between the layers. In existing SSB cell 10 designs, the pressing is performed piece-by-piece or in batch processes, which is time and labor intensive. According to the present disclosure, the two or more layers of the SSB cell 10, such as the anode 14 and solid electrolyte 16, are pressed together in a continuous or semi-continuous process. In this way, components of the SSB cell 10 can be assembled more quickly for construction of the SSB cell 10.

According to one or more embodiments, “continuous” refers to a process that is configured to run at a substantially constant line speed through one or more operations on the processing line. For example, a continuous process may be a roll-to-roll process in which one or more materials are paid off from one or more spools, pass through one or more operations at a substantially constant line speed, and are taken up on another spool at the end of the processing line. According to one or more embodiments, “semi-continuous” refers to a process that is configured to start and stop as the process advances through one or more operations on the processing line. For example, a semi-continuous process may be a roll-to-roll process in which one or more materials are paid off from one or more spools, advance to one or more stations, stop at the one or more stations for an operation to be performed, and advance for take up on another spool.

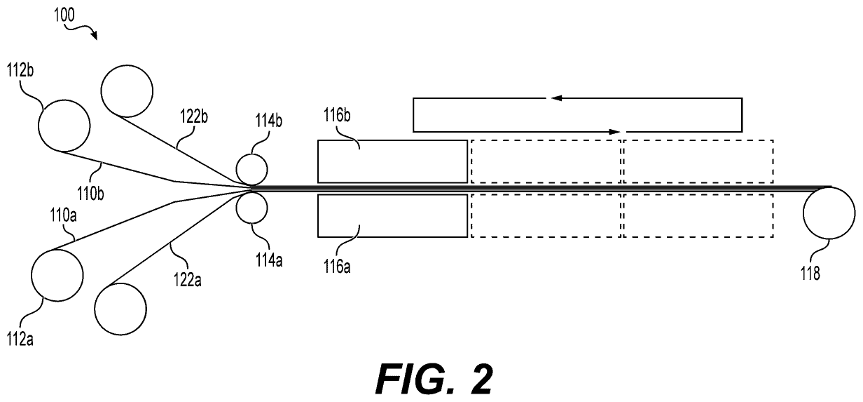

FIG. 2 depicts an embodiment of a process line 100 for pressing two or more component layers 110a, 110b of a solid-state battery. The component layers 110a, 110b can be, for example, electrode materials (cathode 12 or anode 14), solid electrolyte 16, current collectors 18, 20, interlayers, or gasket layers, among others. In one or more embodiments, as shown in FIG. 2, the two or more component layers 110a, 110b are paid off from respective upstream spools 112a, 112b. The two or more component layers 110a, 110b converge (e.g., using lower roller 114a and upper roller 114b) and are pressed between a first pressing chamber 116a and a second pressing chamber 116b. In one or more embodiments, the pressing chambers 116a, 116b are configured to laminate the component layers 110a, 110b together. In the embodiment shown in FIG. 2, the laminated component layers 110a, 110b are taken up on a downstream spool 118.

In one or more embodiments, the first pressing chamber 116a and the second pressing chamber 116b are configured to apply a pressure of at least 50 kPa, in particular in a range of about 50 kPa to about 300 MPa, to the component layers 110a, 110b. As will be understood by those of ordinary skill in the art, the pressure applied by the pressing chambers 116a, 116b will depend on the component layers 110a, 110b being laminated. For example, a pressure as high as 250 MPa may be used to press a lithium foil electrode and a solid electrolyte. However, a pressure as low as 50 kPa may be used to laminate a carbon interlayer to a lithium foil. Further, a gasket may be laminated to a solid electrolyte at a pressure of about 5 MPa to 10 MPa. The pressing chambers 116a, 116b, in particular, are configured to apply the pressure uniformly to each side of the component layers 110a, 110b. In one or more embodiments, the first pressing chamber 116a is configured to apply a first pressure across a first surface area, and the second pressing chamber 116b is configured to apply a second pressure across a second surface area. In one or more embodiments, the first pressure is applied uniformly across the first surface area, and the second pressure is applied uniformly across the second surface area. By “uniformly,” it is meant that the variation in pressure across the first surface area and across the second surface area is 10% or less, in particular 5% or less, and most particularly 2% or less. Further, in one or more embodiments, the first pressure is substantially equal to the second pressure. Because the width and length of the component layers 110a, 110b are much greater than the thickness of the component layers 110a, 110b, the pressing of the component layers 110a, 110b with substantially equal pressure on opposite sides can essentially be considered a form of isostatic pressing.

The terms “substantial,” “substantially,” and variations thereof as used herein, unless defined elsewhere in association with specific terms or phrases, are intended to note that a described feature is equal or approximately equal. In some embodiments, “substantially” may denote values within about 10% of each other, such as within about 5% of each other, or within about 2% of each other. For example, the first pressure being substantially equal to the second pressure means that, in embodiments, the second pressure is no more than 10% greater than or less than the first pressure.

Substantially equal pressure can be applied on the opposite sides of the component layers 110a, 110b using any of a variety of techniques. In an embodiment, substantially equal pressure is applied on opposite sides of the component layers 110a, 110b by supplying fluid hydraulically or pneumatically to each of the pressing chambers 116a, 116b, in particular through a manifold common to the first pressing chamber 116a and to the second pressing chamber 116b. In another embodiment, substantially equal pressure is applied on opposite sides of the component layers 110a, 110b by providing a sealed, flexible fluid bladder in each of the first pressing chamber 116a and the second pressing chamber 116b and driving a ram against one of the sealed, flexible fluid bladders, which transmits pressure through the component layers 110a, 110b to the other scaled, flexible fluid bladder and equalizing the pressures. In still another embodiment, substantially equal pressure is applied on opposite sides of the component layers 110a, 110b by providing a soft rubber pad in each of the pressing chambers 116a, 116b and driving a ram against one of the soft rubber pads, which (like the scaled, flexible fluid bladder) transmits pressure through the component layers 110a, 110b to the other soft rubber pad. In one or more such embodiments, the soft rubber pads are formed from a rubber material having a Shore 00 durometer of 50 or less.

In one or more embodiments, pressure is applied to the component layers 110a, 110b by the pressing chambers 116a, 116b in a manner sufficient to create an adhesive interaction between the component layers 110a, 110b, such as Van der Waals bonding, electrostatic bonding, adsorption, surface tension, or mechanical interlocking. In one or more embodiments, one component layer 110a may be pressed into the porosity or surface roughness of another component layer 110b. For example, lithium metal may be used as an anode 14, and at room temperature, lithium metal is soft and deformable. Thus, when pressing the lithium metal anode 14 against a solid electrolyte 16 (such as sintered lithium garnet), the lithium metal will conform to the surface of the solid electrolyte 16 and flow into pores of solid electrolyte 16.

In one or more embodiments, the component layers 110a, 110b are protected during pressing using a first sealing substrate 122a and a second sealing substrate 122b. As can be seen in FIG. 2, the component layers 110a, 110b are disposed between the first sealing substrate 122a and the second sealing substrate 122b. For example, when the pressing chambers 116a, 116b apply pressuring using a fluid, the sealing substrates 122a, 122b prevent the component layers 110a, 110b from interacting with the fluid. In one or more embodiments, the sealing substrates 122a, 122b comprise at least one of polyethylene, polypropylene, metal foil, or polymer coated metal foil.

In one or more embodiments, the pressing process shown in FIG. 2 can be performed continuously. In such embodiments, the pressing chambers 116a, 116b apply pressure to the component layers 110a, 110b while moving with the component layers 110a, 110b at the line speed. In one or more such embodiments, the process line includes multiple sets of pressing chambers 116a, 116b that alternatingly apply pressure to the component layers 110a, 110b. For example, a first set of pressing chambers 116a, 116b is positioned around a section of the component layers 110a, 110b and travels with the component layers 110a, 110b for a span of the processing line until a sufficient pressure has been applied for a sufficient time to laminate the component layers 110a, 110b together. After the first set of pressing chambers 116a, 116b moves a predetermined distance of the span, a second set of pressing chambers 116a, 116b may be positioned immediately behind the first set of pressing chambers 116a, 116b and travel with the moving component layers 110a, 110b, applying sufficient for a sufficient time to laminate the component layers 110a, 110b together. Depending on the size of each set of pressing chambers 116a, 116b and the length of the span over which the sets of pressing chambers 116a, 116b move, the number of sets of pressing chambers 116a, 116b can vary from two sets of pressing chambers 116a, 116b to, e.g., ten sets of pressing chambers 116a, 116b, or more. When each set of pressing chambers 116a, 116b reaches the end of the span, that set of pressing chambers 116a, 116b may cycle back to the beginning of the span such that, as the component layers 110a, 110b and sealing substrates 122a, 122b move continuously on the processing line, the sets of pressing chambers 116a, 116b cycle to apply substantially uniform pressure over substantially the entire length of the component layers 110, 110b.

In one or more embodiments, the pressing process shown in FIG. 2 can be performed semi-continuously. In such embodiments, the pressing chambers 116a, 116b may be stationary and the component layers 110a, 110b and sealing substrates 122a, 122b (if used) are advanced between the first pressing chamber 116a and the second pressing chamber 116b and stopped while the first pressing chamber 116a and the second pressing chamber 116b are closed around them. The pressing chambers 116a, 116b apply sufficient pressure for a sufficient time to laminate the component layers 110a, 110b, and then, the pressing chambers 116a, 116b are opened to allow the component layers 110a, 110b and sealing substrates 122a, 122b (if used) to advance such that the next section of the component layers 110a, 110b moves between the pressure chambers 116a, 116b. In this way, the component layers 110a, 110b are advanced and pressed in sequential sections.

In one or more embodiments, one of the component layers 110a, 110b may be a solid electrolyte made of a ceramic ribbon. For example, the ceramic ribbon may be made of lithium garnet, such as lanthanum (La) lithium (Li) zirconium (Zr) oxide (O) (LLZO). Optionally, dopant elements may substitute at least one of Li, La, or Zr in LLZO. For example, the lithium garnet may comprise at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c}N_{c})O₁₂, with N=In, Si, Ge, Sn, V, W, Te, Nb, or Ta and 0<c<1; (iv) Li₇₋ₓLa₃(Zr₂₋ₓMₓ)O₁₂, with M=In, Si, Ge, Sn, Sb, Sc, Ti, Hf, V, W, Te, Nb, Ta, Al, Ga, Fe, Bi, Y, Mg, Ca, or combinations thereof and 0<x<1, or a combination thereof. The lithium garnet compositions described herein are merely exemplary, and other lithium garnet compositions may also be used. Such lithium garnet ceramic ribbons are commercially available from Corning Incorporated, Corning, NY.

Further, in one or more embodiments, one of the component layers 110a, 110b may be a metal foil (e.g., for the current collectors 18, 20) comprised of aluminum, copper, nickel, titanium, or stainless steel. Still further, in one or more embodiments, the component layers 110a, 110b may be ceramic ribbons of cathode 12 material or anode 14 material. Additionally, in one or more embodiments, one of the component layers 110a, 110b may be a carbon interlayer (e.g., disposed between a layer of current collector 18, 20 and cathode 12 or anode 14). Furthermore, one of the component layers 110a, 110b may be a gasket layer comprised of an elastomeric or polymeric material.

In one or more embodiments, the pressing is performed at ambient room temperature (e.g., about 20° C. to about 30° C.). In one or more other embodiments, the pressing is performed at an elevated temperature, such as a temperature in a range of ambient temperature to 250° C. In such embodiments, the elevated temperature may assist, for example, with pressing a gasket material to a current collector layer because the elevated temperature may cause the gasket material to melt and flow, providing better engagement between the gasket layer and the current collector. Further, in one or more embodiments, the pressing is performed in a dry room to avoid reaction of any one of the component layers 110a, 110b with water vapor in the air or in a closed inert environment, such as an argon environment, to avoid reaction of any of the component layers 110a, 110b with oxygen.

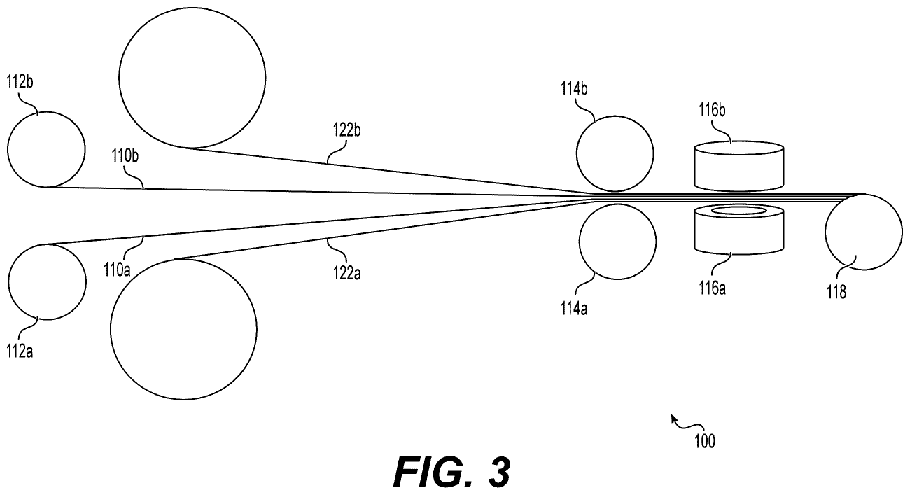

While the foregoing embodiments have primarily related to pressing of continuous ribbons, films, or strips together, the disclosed continuous and semi-continuous processes can be used to press discrete component parts together as shown in FIG. 3. As can be seen in FIG. 3, the process line 100 includes component layers 110a, 110b paid off from upstream spools 112a, 112b converged at rollers 114a, 114b. The component layers 110a, 110b are pressed between a first pressing chamber 116a and a second pressing chamber 116b and then taken up on a downstream spool 118. Further, as can be seen in FIG. 3, the component layers 110a, 110b are disposed between sealing substrates 122a, 122b.

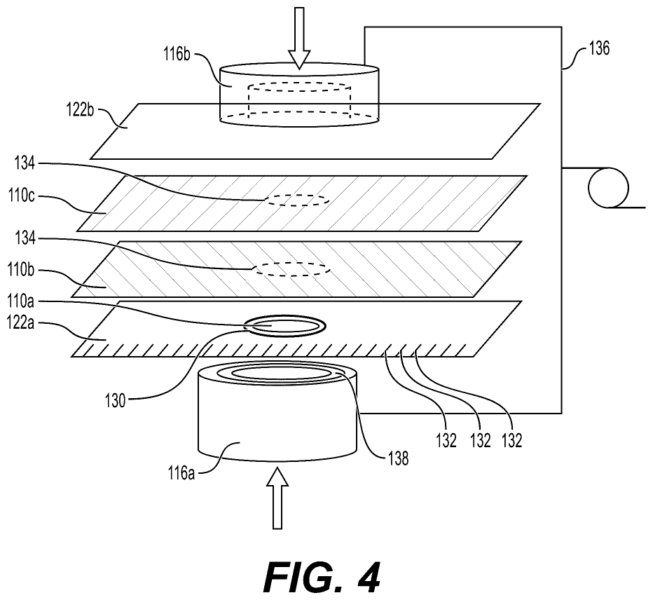

FIG. 4 provides a detail view of the pressing chambers 116a, 116b of FIG. 3. As can be seen in FIG. 4, the pressing chambers 116a, 116b are configured to press a button or coin cell-style SSB cell 10. In this regard, the first pressing chamber 116a and the second pressing chamber 116b each define a cylindrical cavity configured to apply substantially equal pressure to each side of the stack of component layers 110a, 110b, 110c, which include a solid electrolyte 110a, carbon interlayer 110b, and current collector 110c in the example embodiment depicted. Further, while a circular button or coin cell-style SSB cell 10 is depicted, the pressing chambers 116a, 116b can be configured to press stacks of other shapes, such as rectangular, square, other polygonal or curved shapes, or shapes including straight and curved sides.

In the embodiment shown in FIG. 4, the solid electrolyte component layer 110a is pre-cut to the desired SSB cell 10 dimensions and seated as a discrete component part into the first sealing substrate 122a. In this way, the first sealing substrate 122a acts as a carrier for the solid electrolyte component layer 110a. In one or more such embodiments, the first sealing substrate 122a includes an embossed alignment feature 130 into which the solid electrolyte component layer 110a is seated. In one or more other embodiments, the alignment feature 130 is instead a patch of adhesive (such as silicone or acrylic adhesive, among others). Further, as shown in FIG. 4, the first sealing substrate 122a includes venting channels 132 through which air between the component layers 110a, 110b, 110c can be evacuated during pressing. However, in one or more other embodiments, the venting channels 132 may be omitted if the pressure is applied during pressing in a way that forces air between the sealing substrates 122a, 122b out from between the component layers 110a, 110b, 110c (e.g., applied radially from the center out or from one side to another).

The other component layers 110b, 110c of the stack may also be configured for pressing into near net-shape of the SSB cell 10. For example, as shown in FIG. 4, each of the carbon interlayer component layer 110b and the current collector component layer 110c include perforations 134 in the shape of the solid electrolyte. In this way, the pressed stack of component layers 110a, 110b, 110c can more easily be separated from the continuous ribbons or strips of component layers 110b, 110c. Further, the second sealing substrate 122b or another carrier film may include an adhesive patch onto which one of the component layers 110b, 110c is adhered as a discrete component part.

In the embodiment shown in FIG. 4, the pressing chambers 116a, 116b are connected to a common manifold 136 for supplying of pressurized fluid to the pressing chambers 116a, 116b. In such an embodiment, the sealing substrates 122a, 122b surround and protect the component layers 110a, 110b, 110c from the fluid. Further, as shown in FIG. 4, one or both of the pressing chambers 116a, 116b may include a gasket 138 to help seal or pinch off the sealing substrates 122a, 122b around the stack of component layers 110a, 110b, 110c after the air has been evacuated. In order to entirely seal the stack of component layers 110a, 110b, 110c from the fluid in the pressing chambers 116a, 116b, the sealing substrates 122a, 122b are wider than the diameter of the cavity defined by the pressing chambers 116a, 116b.

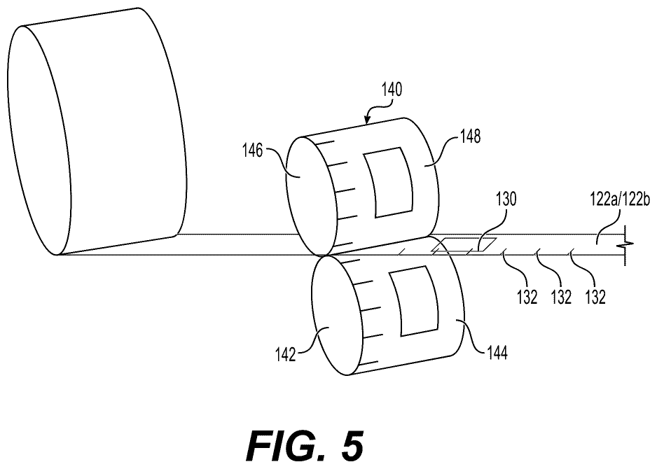

FIG. 5 depicts an embodiment of embossing rollers 140 configured to form the alignment feature 130 and venting channels 132 in one of the first sealing substrate 122a or the second sealing substrate 122b. As can be seen in FIG. 5, the embossing rollers 140 include a first roller 142 having a negative surface 144 of the alignment feature 130 and venting channels 132 and a second roller 146 having a positive surface 148 of the alignment feature 130 and venting channels 132. When the first or second sealing substrate 122a, 122b passes between the first roller 142 and the second roller 146, the negative surface 144 and positive surface 148 cooperate to emboss the first or second sealing substrate 122a, 122b therebetween. As mentioned, the embossed alignment feature 130 may be used to position a component layer as a discrete part, and the embossed venting channels 132 may be used to evacuate air from the stack of component layers prior to pressing.

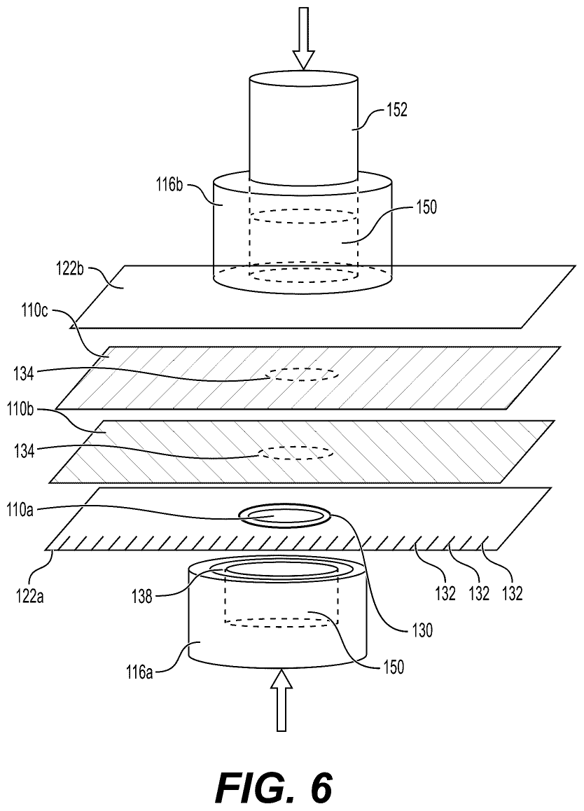

FIG. 6 depicts another embodiment of the pressing chambers 116a, 116b. Like the embodiment shown in FIG. 5, the embodiment of FIG. 6 is configured to press a stack of component layers 110a, 110b, 110b in which at least one component layer 110a is near net-shape for the SSB cell 10. As depicted in FIG. 6, the first component layer 110a is a solid electrolyte discrete component part seated within an alignment feature 130 of the first sealing substrate 122a, and the other two component layers 110b, 110c, which may be a carbon interlayer and a copper current collector, include perforations 134 aligned with the alignment feature 130. As mentioned above, at least one of the other component layers 110b, 110c may also be a discrete component part adhered to the second sealing substrate 122b or to another carrier film. The pressing chambers 116a, 116b may be closed around the stack of component layers 110a, 110b, 110c to laminate the component layers 110a, 110b, 110c together. In the embodiment shown in FIG. 6, the pressing chambers 116a, 116b each include flexible, sealed bladders or soft rubber pads 150, and a ram 152 is pressed against one of the bladders or pads 150 to transmit pressure from one bladder or pad 150, through the stack of component layers 110a, 110b, 110c and sealing substrates 122a, 122b, to the other bladder or pad 150, creating substantially equal pressure applied by each of the pressing chambers 116a, 116b on the stack of component layers 110a, 110b, 110c.

When pressing component layers 110a, 110b, 110c that include discrete component parts, advancing the component layers 110a, 110b, 110c (whether as ribbon substrates with perforations 134 or carrier films with adhesive patches) and sealing substrates 122a, 122b with alignment features 130 (if used) in coordination facilitates accurate and efficient lamination of the component layers 110a, 110b, 110c. In such embodiments, coordination between the component layers 110a, 110b, 110c and the sealing substrates 122a, 122b can be maintained in a variety of ways. For example, in one or more embodiments, the component layers 110a, 110b, 110c and/or sealing substrates 122a, 122b include a registering feature that cooperates with a corresponding feature on the downstream spool (such as downstream spool 118 of FIG. 3) that rotates to advance the component layers 110a, 110b, 110c and the sealing substrates 122a, 122b. An example registering feature can be a plurality of punched holes, and an example of the corresponding feature can be teeth disposed around the perimeter of the downstream spool 118. In another example, according to one or more embodiments, the component layers 110a, 110b, 110c and/or sealing substrates 122a, 122b are synchronized manually or by using lasers or optical marks that can be read to automatically align the leading edges before attaching them to the downstream spool 118. In still another example, according to one or more embodiments, the leading edges of the component layers 110a, 110b, 110c and/or the sealing substrates 122a, 122b can be connected through heat pressing to fuse the layers together or by pinning (e.g., stapling), bonding (e.g., UV-curable epoxy or pressure-sensitive adhesive), or otherwise clamping the layers together. Once the component layers 110a, 110b, 110c and/or sealing substrates 122a, 122b are aligned initially, the coordination between the layers should be maintained as long as proper tension is maintained such that the layers do not stretch as the process proceeds.

According to any of the foregoing embodiments, after pressing, the sealing substrates 122a, 122b may be taken up on the downstream spool 118 with the component layers 110a, 110b, 110c, or alternatively, one or both of the sealing substrates 122a, 122b may be removed prior to taking the component layers 110a, 110b, 110c up on the downstream spool 118. For example, the sealing substrates 122a, 122b can be removed by peeling them apart downstream of the pressing chambers 116a, 116b, such as by taking them up on spools separate from the downstream spool 118. In one or more embodiments, the component layers 110a, 110b, 110c can be separated from the sealing substrates 122a, 122b or from respective carrier films using dissolvable polymers, such as polyethylene oxide, which is soluble in common solvents like ethanol and isopropanol. Additionally, the sealing substrates 122a, 122b or carrier films for the component layers 110a, 110b, 110c could be heated to facilitate release of the component layers 110a, 110b, 110c. Still further, a metal foil (e.g., copper, nickel, or stainless steel) could be positioned between the component layers 110a, 110b, 110c and the sealing substrates 122a, 122b to prevent adhesion between the component layers 110a, 110b, 110c and the sealing substrates 122a, 122b.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element and is not intended to be construed as meaning only one.

It will be apparent to those skilled in the art that various modifications and variations can be made without departing from the spirit or scope of the disclosed embodiments. Since modifications, combinations, sub-combinations, and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method, comprising:
advancing two or more component layers of a solid-state battery in a first direction, the two or more component layers comprising at least one of continuous ribbon substrate or a carrier film;
pressing the two or more component layers between a first pressing chamber and a second pressing chamber to laminate the two or more component layers of the solid-state battery;
wherein the first pressing chamber is configured to apply a first pressure uniformly over a first surface area and the second pressing chamber is configured to apply a second pressure uniformly over a second surface area, the first pressure being substantially equal to the second pressure and the first surface area being substantially equal to the second surface area.

2. The method of claim 1, wherein advancing the two or more component layers further comprises advancing the two or more component layers between a first sealing substrate and a second sealing substrate and wherein the first sealing substrate prevents contact between the two or more component layers and the first pressing chamber and the second sealing substrate prevents contact between the two or more component layers and the second pressing chamber.

3. The method of claim 2, further comprising embossing the first sealing substrate with a plurality of alignment features, wherein embossing occurs prior to advancing and wherein one component layer of the two or more component layers comprises discrete component parts seated within each of the plurality of alignment features.

4. The method of claim 3, wherein each discrete component part is a solid electrolyte layer of the solid-state battery.

5. The method of claim 3, wherein another component layer of the two or more component layers comprises the continuous ribbon substrate and has formed therein a plurality of perforations, each perforation aligned with an alignment feature of the plurality of alignment features.

6. The method of claim 3, wherein another component layer of the two or more component layers comprises the carrier film and has a plurality of further discrete component parts adhesively attached to the carrier film.

7. The method of claim 5, wherein the another component layer of the two or more component layers is advanced in coordination with the first sealing substrate.

8. The method of claim 7, wherein the another component layer of the two or more component layers comprises a first leading edge, wherein the first sealing substrate comprises a second leading edge, and wherein the first leading edge and the second leading edge are synchronized using laser alignment or optical alignment markings.

9. The method of claim 7, wherein the another component layer of the two or more component layers comprises a first leading edge, wherein the first sealing substrate comprises a second leading edge, and wherein the another component layer and the first sealing substrate are fused, bonded, pinned, or clamped together proximal to the first leading edge and the second leading edge.

10. The method of claim 1, further comprising passing the two or more component layers through a set of rollers to converge the two or more component layers prior to pressing.

11. The method of claim 1, wherein pressing further comprises a first pressing, a second pressing, or a third pressing, and wherein:
the first pressing includes:
closing the first pressing chamber and the second pressing chamber around a section of the two or more component layers, the section corresponding to the first and second surface areas over which the pressure is uniformly applied; and
pressurizing the first pressing chamber and the second pressing chamber with a fluid to compress the section of the two or more component layers, the fluid supplied through a manifold common to the first pressing chamber and the second pressing chamber;
the second pressing includes:
closing the first pressing chamber and the second pressing chamber around a section of the two or more component layers, the first pressing chamber comprising a first bladder containing a fluid and the second pressing chamber comprising a second bladder containing a fluid; and
driving a ram against the first bladder such that pressure is transmitted through the first bladder and the two or more component layers to the second bladder so as to compress the section of the two or more component layers between the first bladder and the second bladder; and
the third pressing includes:
closing the first pressing chamber and the second pressing chamber around a section of the two or more component layers, the first pressing chamber comprising a first rubber pad and the second pressing chamber comprising a second rubber pad, each of the first rubber pad and the second rubber pad comprising a rubber material having a Shore 00 durometer of 50 or less; and
driving a ram against the first rubber pad such that pressure is transmitted through the first rubber pad and the two or more component layers to the second rubber pad so as to compress the section of the two or more component layers between the first rubber pad and the second rubber pad.

12. The method of claim 1, wherein one or more of (i) pressing comprises applying a pressure of at least 50 kPa to the two or more component layers, (ii) a temperature during pressing of the two or more component layers is 250° C. or less, and (iii) advancing and pressing is performed continuously or semi-continuously.

13. The method of claim 1, wherein the two or more component layers of the solid-state battery are selected from a group consisting of electrodes, interlayers, current collectors, solid electrolyte, gaskets, and combinations thereof.

14. A system, comprising:
a plurality of upstream spools configured to pay off two or more component layers of a solid-state battery, the two or more component layers comprising at least one of a continuous ribbon substrate or a carrier film;
a set of rollers downstream of the plurality of upstream spools, the set of rollers configured to converge the two or more component layers in a stacked arrangement; and
a press disposed downstream of the set of rollers, the press comprising a first pressing chamber and a second pressing chamber configured to apply pressure to a section of the two or more component layers to laminate the two or more component layers in the section;
wherein the first pressing chamber is configured to apply a first pressure uniformly over a first surface area and the second pressing chamber is configured to apply a second pressure uniformly over a second surface area, the first surface area being substantially equal to the second surface area and the section of the two or more component layers corresponding to the first surface area and the second surface area over which the pressure is uniformly applied; and
wherein the first pressure is substantially equal to the second pressure.

15. The system of claim 14, wherein the first pressing chamber and the second pressing chamber apply pressure to the section using a fluid supplied through a common manifold.

16. The system of claim 14, wherein the press further comprises a ram in a first configuration or a second configuration;
wherein, in the first configuration:
the first pressing chamber comprises a first bladder containing a fluid and the second pressing chamber comprises a second bladder containing a fluid; and
the ram is configured to be driven against the first bladder such that pressure is transmitted through the first bladder and the two or more component layers to the second bladder so as to compress the section between the first bladder and the second bladder; and
wherein, in the second configuration:
the first pressing chamber comprises a first rubber pad and the second pressing chamber comprises a second rubber pad; and
the ram is configured to be driven against the first rubber pad such that pressure is transmitted through the first rubber pad and the two or more component layers to the second rubber pad so as to compress the section between the first rubber pad and the second rubber pad.

17. The system of claim 14, wherein the plurality of upstream spools is further configured to pay off a first sealing substrate and a second sealing substrate such that the two or more component layers are disposed between the first sealing substrate and the second sealing substrate; and
wherein the first sealing substrate prevents contact between the two or more component layers and the first pressing chamber and the second sealing substrate prevents contact between the two or more component layers and the second pressing chamber.

18. The system of claim 17, wherein the first sealing substrate comprises a plurality of embossed alignment features, wherein one component layer of the two or more component layers comprises discrete component parts seated in the plurality of embossed alignment features.

19. The system of claim 18, wherein another component layer of the two or more component layers comprises the continuous ribbon substrate and has formed therein a plurality of perforations, each perforation aligned with an embossed alignment feature of the plurality of embossed alignment features.

20. The system of claim 18, wherein another component layer of the two or more component layers comprises the carrier film and has a plurality of further discrete component parts adhesively attached to the carrier film.
